(19) United States
(12) Patent Application Publication
(10) Pub. No.: US 2005/0194341 A1
(43) Pub. Date: Sep. 8, 2005

(54) Disposable pre filled baby bottle delivery system

(76) Inventor: F. William Houraney, Loxahatchee, FL (US)

Correspondence Address: F. WILLIAM HOURANEY, 15316 HAMLIN BLVD., LOXAHATCHEE, FL, 33470, US

(21) Appl. No.: 10/794,903

(22) Filed: Mar. 8, 2004

(51) Int. Cl. A61J 9/00

(52) U.S. Cl. 215/11.1; 215/11.6

(57) ABSTRACT

This invention relates to a disposable pre filled baby bottle delivery system, specifically designed to assist the caretaker in the ease and convenience of the feeding, the nutritional supplementation, medicinal intake, or the pacifying of an infant or toddler without the necessity of a refrigerated storage. The small form container is filled with a sterilized liquid and hermetically sealed at the opening with a removable membrane. The nipple is a molded lollipop type structure that is formulated to provide an appealing taste so as to encourage the infant or toddler to drink the liquid or simply pacified by sucking on the flavored nipple. The nipple is covered with a rigid plastic and sealed with a thin plastic film.

### FIELD OF INVENTION

This invention relates to a disposable pre filled baby bottle delivery system specifically designed for infants and toddlers that will aid the caretaker in the ease and convenience of the feeding, the nutritional supplementation, and the pacifying of the baby or toddler.

### BACKGROUND OF THE INVENTION

Various devices exist which provide delivery systems for the transfer of formula, juices, vitamins, etc to a baby or a toddler. Baby bottles are well known in the art. Conventional baby bottles (also referred to herein as delivery systems or feeding systems) include a glass or plastic container having an externally threaded container opening, a bottle feeding nipple, and a screw-on top for securing the nipple to the container. A standard nipple, which is defined herein to mean a feeding nipple of the type commonly used with reusable baby bottles utilizing screw-on caps, is commonly made of either natural or synthetic rubber, both of which are flexible and compressible. Standard nipples are available for premature infants, newborns, and toddlers. An opening in the tip end (also referred to as the mouth portion) of the nipple permits liquid to be withdrawn from the container in response to a sucking action by the nursing infant. The size of the opening in the tip end of the nipple (also referred to as the nipple opening) varies. For a premature baby, the nipple opening is typically a small pinhole. For older infants and toddlers, the nipple opening is often in the form of a cross-cut or “X” to permit the infant to receive more liquid in response to the sucking action.

Care givers normally feed infants milk, formula, juices, and water from a baby bottle. In addition, some infants, especially older infants and toddlers, receive dilute mixtures such as cereal-formula or thinned vegetables via baby bottle. As used herein, the terms “liquid” and “beverage” are used interchangeably to include all forms of nutrition capable of administration to infants through a nipple.

Reusable baby bottles are major sources of concern for parents and other care givers. Bottle preparers must properly clean and sterilize baby bottles, bottle feeding nipples, and caps to prevent introduction of harmful contaminants into infant formula and other beverages to be consumed by the infant. The sterilization process is time consuming; moreover, the bottle preparer may fail to clean a reusable baby bottle thoroughly and thereby place the infant at risk.

Preparation of the beverage also presents risks. Formula and juices frequently require dilution of a concentrate using water. A simple mistake in understanding directions or in the measurement of the ingredients of an infant beverage may subject the infant to gastric distress or nutritional imbalances. Although some contaminants and bacteria are not harmful to adults, infants are especially sensitive because their systems have not yet fully developed. Dilution water and ordinary tap water in particular, may contain trace amounts of minerals or bacteria which are harmful to infants. Chlorination of drinking water, although common throughout most of the United States, is not universal. Water systems in remote locations often lack the chlorine residual necessary to sanitize the water for drinking purposes. While the use of bottled water reduces the risk of contamination, bottle preparers may not seal the bottled water between uses.

Assuming the bottle preparer properly sterilizes bottle parts and correctly dilutes the concentrated infant beverage with suitable dilution water, reusable baby bottles present additional problems. The bottle preparer may incorrectly estimate the amount of formula a baby may need, resulting in wasted formula. Prepared baby bottles must be refrigerated prior to use, which in turn creates inconvenience and expense for transporting a baby bottle. Baby bottles also tend to leak through the nipples when the baby bottles are subjected to mechanical forces, causing clothes and other objects to be stained or damaged by the leaking beverage.

Description of the Prior Art

Because of the need of the caregivers to have a portable supply of milk or other liquids, and the need to keep opened but unused containers of milk refrigerated between uses, a number of individual, prepackaged containers of milk or other liquid nutrients have been developed. Many of these containers include nipples and nipple attachment means.

For example, the disposable baby bottle of Howland (U.S. Pat. No. 3,746,198) is essentially the same as previous bottles in shape but is vacuum sealed and has a threaded cap to removably receive a nipple. The nipple may be provided in sterilized form in a sealed cap to the baby bottle. Other liquid containers may be used with standard nipples. The disposable baby bottle of Rane (U.S. Pat. No. 4,678,092) is a substantially cylindrical pouch terminating at an open end and containing a premeasured amount of liquid. An annular ring covered by a sealing cover with a pull tab is molded to the open end. A conventional ring and nipple assembly can be threaded on to the annular ring after removal of the sealing cover. The disposable nursing container of Rowland (U.S. Pat. No. 5,273,171) speaks of a rectangular paperboard container with a flexible plastic nipple attachment that is molded with a puncture piece for access to the liquid.

The baby-feeding packs of Hammond (U.S. Pat. No. 4,830,205) are flexible pouch-like bags having a liquid-containing compartment, and an auxiliary compartment with a folded gusset for containing the nipple. When the gusset is inverted after opening of the auxiliary compartment, the nipple is presented for access.

The nursing container of Cabemoch et al. (U.S. Pat. No. 4,706,827) has a rigid outer container, for example, of rigid plastic and an inner flexible container. A self-opening nipple assembly is sealed to the flexible pouch and attached to the inside of the rigid container. A nipple access member inside the nipple is used to puncture the flexible container. The disposable nursing device of Eckholm (U.S. Pat. No. 3,777,925) has an inwardly tapering upper outer housing of rigid material, and an inner collapsible thin-walled bag. The top of the housing is adapted to receive a nipple.

And Little (U.S. Pat. No. 5,932,262) describes a method of flavoring a silicone or latex type nipple by soaking the nipple in a flavored solution for up to 2 weeks in order to provide for a flavored nipple.

Many of the prior disposable containers do not provide the caregiver with the ease and convenience of transporting a plurality of containers in a small bag, pocketbook, etc. For portable use, prepackaged liquids for babies and infants, which do not include nipples, require that a nipple be separately cleaned, sterilized, and carried by the user. In addition, with many of the prior nursing containers, particularly the disposable ones or others made of non-transparent materials; it is difficult to determine how much of the liquid has been consumed. Also the prior art does not present the small form factor and the aesthetic and functional appeal inherent in the present invention.

The present invention obviates the disadvantages associated with those previous bottles by providing an improved disposable delivery system that is appealing and practical for the baby, easy and convenient to use for the caretaker, and one which can economically manufactured thus reducing feeding costs.

### OBJECTS AND ADVANTAGES

Accordingly, several objects and advantages of the present invention are:
a. to provide a disposable pre filled baby bottle delivery system that is attractive and practical so as to encourage the consumption by the baby or toddler.
b. to provide a disposable pre filled baby bottle delivery system that is easy and convenient for the caretaker at anytime and in any place.
c. to provide a disposable pre filled baby bottle delivery system with a small form factor that makes it practical and convenient to carry multiple units in numerous types of carry bags.
d. to provide a disposable pre filled baby bottle delivery system which is factory-sealed and leak-resistant.
e. to provide a disposable pre filled baby bottle delivery system which the contents are sterilized and the expiration date is labeled at the factory.
f. to provide a disposable pre filled baby bottle delivery system which ensures proper proportioning of water, formula, medicines, and nutrients in infant beverages.
g. to provide a disposable pre filled baby bottle delivery system which eliminates the need for refrigeration and/or preparation of the infant beverage at the point of use.
h. to provide a disposable pre filled baby bottle delivery system which can be easily stocked in all markets without the need of refrigeration.
i. to provide a disposable pre filled baby bottle delivery system which is economical to manufacture and thus a greater value to the caretaker.

Other objects, features, and advantages of the present invention will become clear from the following description of the preferred embodiment when read in conjunction with the accompanying drawings and claims.

### SUMMARY OF THE INVENTION

This invention relates to a disposable pre filled baby bottle delivery system, specifically designed for infants and toddlers that will aid the caretaker in the ease and convenience of the feeding, the nutritional supplementation, and the pacifying of the baby or toddler. The size, shape, and design of the present invention is predicated around the function, and practicality necessary to appeal to the infant or toddler who many times resist feedings or nutritional supplementation. The structure and makeup of the nipple is both functional and appealing therefore encouraging the consumption of the contents by the infant or toddler.

The present invention eliminates cleaning and sterilizing of conventional baby bottle containers, nipples, and screw tops. This disposable pre filled baby bottle delivery system also eliminates beverage preparation and refrigeration of the filled baby bottle. When filled with premixed liquid, this invention is ready to use, can be available at anytime or anyplace when the baby or toddler is ready to eat or simply needs a pacifier.

Contents of the disposable pre filled baby bottle delivery system can be controlled precisely at the factory. For example, the factory can purify water efficiently and economically on a large scale for mixing with infant nutrients. Also, the factory can provide UHT (Ultra High Temperature) milk for toddlers feeding on regular milk so that refrigeration is unnecessary.

Many infant beverages, including milk and orange juice, are perishable and may not be left unsealed at ambient temperatures because they become unfit for infant consumption. The disposable pre filled baby bottle delivery system of the present invention is sterilized and sealed to prevent spoilage, so refrigeration is unnecessary. In practice, when it is desired to begin feeding, the sealing cover is removed making it ready for use.

Factory preparation of the formula or liquid permits date-stamping of this disposable pre filled baby bottle delivery system (and its contents), thereby providing valuable information to parents and care givers regarding the sealed contents.

### BRIEF DESCRIPTION OF THE DRAWINGS

A more complete understanding of the invention can be had by reference to the following Detailed Description taken in conjunction with the accompanying Drawings in which:

FIG. 1 is a perspective view of the present invention;

FIG. 2 shows a side view of the present embodiment;

FIG. 3 shows a top view of the present embodiment;

FIG. 4 is an exploded perspective view of the present invention;

FIG. 5 is a top view of the disposable container of FIG. 2 with the hermetic seal attached and unopened;

FIG. 6 is a cross sectional view of the nipple assembly taken on line A-A of FIG. 2;

FIG. 7 is a top view of the nipple assembly 9 of FIG. 6 illustrating the candy nipple prior to the opening of the liquid passageway;

FIG. 8 is a top view of the nipple assembly 9 of FIG. 6 illustrating the candy nipple after the passageway opening has been exposed.

### DETAILED DESCRIPTION OF THE INVENTION

Referring now to the Drawings wherein like reference numerals designate like or corresponding parts throughout;

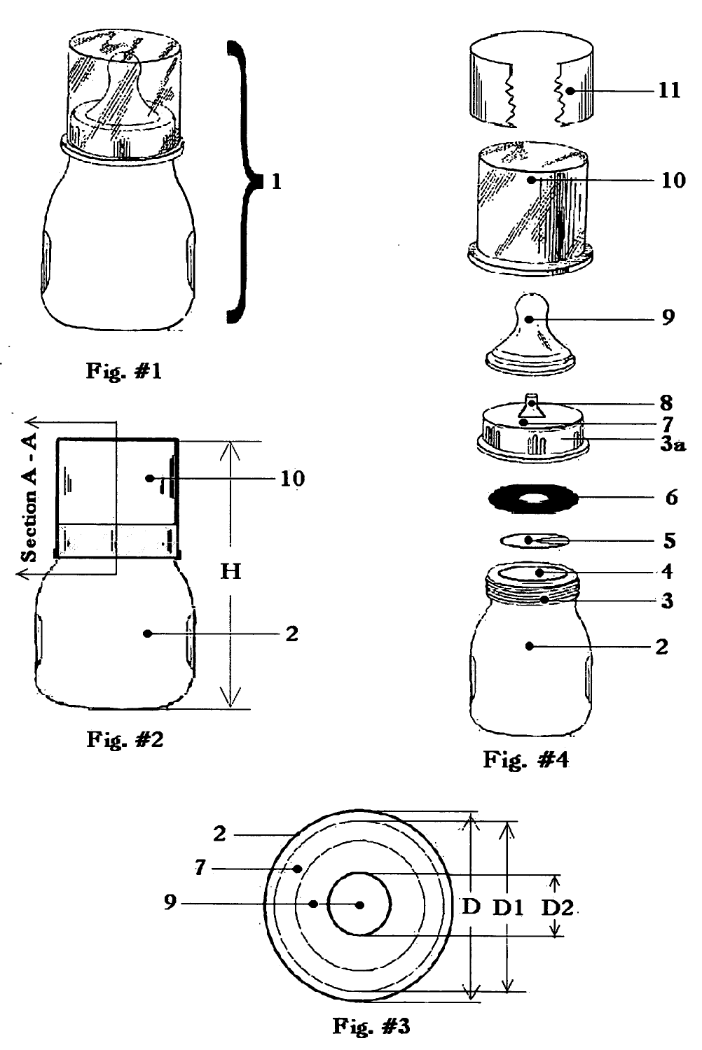

FIG. 1 shows a perspective representation of the disposable pre filled baby bottle delivery system of the present invention.

FIG. 2 shows a side view of the present embodiment with a height H from the bottom of the container 2 to the top of the cover 10 at approximately 3½ inches.

FIG. 3 shows a top view of the present embodiment with a diameter D of the container 2 at 1½ inches and the diameter D1 of the cap 7 at 1¼ inches. The diameter D2 at the top of the nipple 9 is shown at approximately ½ inches.

FIG. 4 is an exploded view of the disposable pre filled baby bottle arrangement of FIG. 1. With additional reference to FIG. 4, the disposable pre filled baby bottle delivery system 1 includes several basic component parts. The basic component parts include a container 2 with threaded top 3 and opening 4, a sealing cover 5, a paper washer 6, a cap 7 with open extension 8, a nipple 9, a cover 10 and a flexible transparent seal 11. The container 2 and the cap 7 may be constructed of any suitable materials generally known and employed in the art. Preferably, non-toxic, impact and corrosion resistant, plastic/polymeric materials form these components. Generally, the container 2 and cap 7 can be constructed for use with many devices in the art. For example, an upper outer surface of the container 2, near the opening 4, can be provided with threads 3 thereabout. The inner side surfaces within the cap 7 can also be provided with threads 3a. The threads 3 of the container 2 are adapted to engage and mate with the threads 3a provided within the cap 7 in such a fashion as to permit a person to manually screw the cap 7 in place atop the container 2 and with the paper washer 6 between the cap 7 and the container 2, form a substantially leak proof seal.

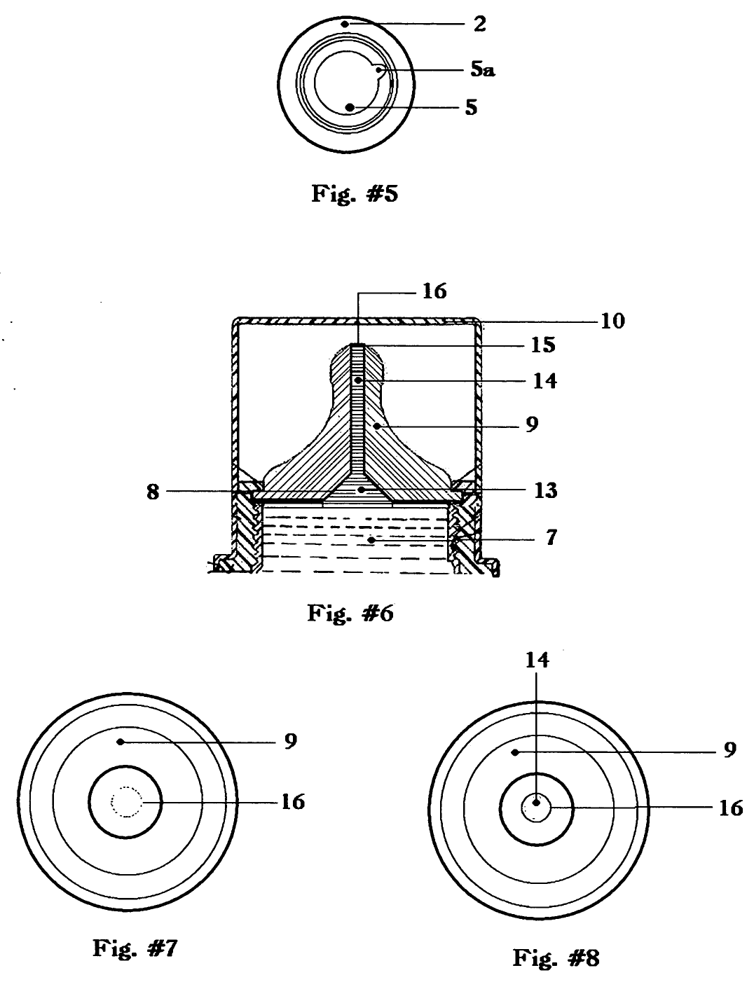

FIG. 5 is a top view of the container 2 showing the sealing cover 5 and the outwardly extended tab 5a which helps to facilitate the easy and quick removal of the sealing cover 5 by hand at the time of use. The sealing cover 5 is a thin membrane that can be constructed of either the same material as the container 2 or a thin aluminum.

FIG. 6 is a cross section taken along ‘A-A’ of FIG. 2. The nipple 9 is disposed on top of the cap 7. The nipple 9 is made of hard candy, similar to a lollipop. This candy nipple is molded on top of the cap 7 with a funnel like intrusion 13 on the bottom which is supported by the cap extension 8. The opening passageway 14 is approximately ⅛″ diameter and is the means by which the liquid flows from the container to the mouth of the nipple 15. At the tip or uppermost portion 15 of the nipple, a thin layer 16 of candy coating is molded to seal the passageway 14. The feeding tip 15 is constructed in a manner permitting a child to dissolve the candy seal 16 and draw a liquid through the opening 14 upon application of a minimal sucking force. The quantity and consistency of the nipple 9 is adequate so as to provide for an ample platform for the drawing of the total liquid content prior to the dissipation of the nipple 9 and the exposure of the passageway funnel base 13. The cover 10 is shown in section view enclosing nipple 9 and cap 7.

FIG. 7 is a top view of the molded nipple 9 before the candy seal 16 is dissolved.

FIG. 8 is a top view of the molded nipple 9 after the candy seal 16 is dissolved therefore exposing the passageway 14 and facilitating the drawing of the liquid content into the mouth of the baby or toddler.

In summary, a disposable pre-filled bottle delivery system has been disclosed which is simple in construction and which can be easily and economically manufactured The bottle is preferably constructed of flexible, non-breakable plastic material and the nipple is made of various formulas and flavorings of hard candy. The size, design and construction of the present invention aid in the appeal to the baby or toddler. The disposable bottle or container includes a measured amount of feeding liquid. The liquid content is sterilized to insure hygiene and an extended shelf life. A membrane is heat sealed onto the container to prevent contamination of this liquid content. A dissolvable nipple constructed of candy similar to a lollipop, is attached to the top of the liquid container. The flavored candy nipple helps to encourage the child to drink the liquid contents while acting as the conduit for the liquid to flow into the mouth of the child and also acts as a structure in which to formulate a prescribed nutritional, pharmaceutical, and or a medicinal prescribed value of ingredients.

1. A disposable pre filled baby bottle delivery system, comprising:
(a) a disposable container, wherein the container is constructed from a substantially cylindrical, lightweight, liquid impermeable plastic, said container having a threaded or fitted upper end for engagement to a threaded or pressure fitted cap;
(b) a removable sealing membrane disposed at the top open end of said container, said removable membrane comprises a thin wall formed as an integral part of said container and capable of being thermically sealed about the top of said container providing a means to hermetically seal said container and the liquid contents within and said removable sealing membrane being constructed of a thin aluminum or of the same material as said container;
(c) a the fitted or threaded rigid cap affixed on top of said container and said removable seal;
(d) a nipple device constructed of flavored hard candy affixed atop said cap;
(e) a plastic cover which is removably disposed on said cap;
(f) a strip of plastic capable of being hermetically sealed about the flanges of said cover and said cap and a portion of said container below the threaded or fitted area thereof, whereby said cap and said candy nipple are kept sterilized until the said cover is removed.

2. A disposable pre filled baby bottle delivery system as recited in claim 1, wherein the dimension and the shape of the container is constructed so as to conform to the small size of the palm of an infant or toddler.

3. A disposable pre filled baby bottle delivery system as recited in claim 1 wherein the fitted or threaded cap provides a rigid cover for the container on top of the removable seal and said cap comprises a rigid base for said nipple device and wherein said cap is constructed with a centrally located funnel shaped opening so as to provide a means for the liquid to flow into the passageway of said nipple device.

4. A disposable pre filled baby bottle delivery system as recited in claim 1 wherein the nipple device is constructed of flavored hard candy similar to a lollipop wherein the quantity and consistency of the candy structure is adequate so as to provide for an ample platform for the drawing of the total liquid content prior to the dissipation of said nipple device and the candy structure of said nipple device provides for numerous flavors and tastes encouraging the infant or toddler to draw the liquid content.

5. A disposable pre filled baby bottle delivery system as recited in claim 4 wherein said nipple device is constructed with an open passageway located centrally and running the longitudinal length of said nipple device providing a means wherein the liquid passes from said container to the top of said nipple device thus flavoring the liquid with the designated candy taste as the liquid passes along said passageway to the mouth of the infant or toddler.

6. A disposable pre filled baby bottle delivery system as recited in claim 4 wherein said nipple device is constructed with a minimal amount of the molded candy covering the open passageway at the top of the said nipple device to facilitate a candy seal of the said passageway until such time as the mouth of the infant or toddler dissolves said candy seal.

7. A disposable pre filled baby bottle delivery system as recited in claim 4 wherein said nipple device is flavored to compliment the liquid contents such as, but not limited to; a vanilla, chocolate, or strawberry flavored candy nipple to compliment a milk or soy based liquid, or a lemon or ice tea flavoring to compliment a water liquid content.

8. A disposable pre filled baby bottle delivery system as recited in claim 4 wherein the make up structure and material formula of said nipple device has prescribed values of medicinal, nutritional, or pharmaceutical ingredients.

9. A disposable pre filled baby bottle delivery system as recited in claim 1 wherein the liquid content of said container is neutral such as but not limited to, water; enriched such as, but not limited to, milk or formula; or medicinal such as but not limited to, cough syrup.

10. A disposable pre filled baby bottle delivery system as recited in claim 1 wherein the said container is void of any liquid therefore providing an appealing and flavored small form baby bottle pacifier.
